(19) United States
(12) Patent Application Publication
(10) Pub. No.: US 2022/0349122 A1
(43) Pub. Date: Nov. 3, 2022

(54) INKJET TEXTILE PRINTING TREATMENT LIQUID, INKJET TEXTILE PRINTING APPARATUS, INKJET TEXTILE PRINTING METHOD, AND TEXTILE PRINT

(71) Applicant: KYOCERA Document Solutions Inc., Osaka-shi, Osaka (JP)

(72) Inventor: Jun HIOKI, Osaka-shi, Osaka (JP)

(73) Assignee: KYOCERA Document Solutions Inc., Osaka (JP)

(21) Appl. No.: 17/633,524

(22) PCT Filed: Apr. 7, 2021
(86) PCT No.: PCT/JP2021/014733

§ 371 Date: Feb. 7, 2022

(30) Foreign Application Priority Data
Apr. 13, 2020 (JP) 2020-071699

(51) Int. Cl. D06P 5/30; C09D 11/38; C09D 11/54

(52) U.S. Cl. CPC D06P 5/30; C09D 11/38; C09D 11/54

(57) ABSTRACT

An inkjet textile printing treatment liquid contains an aqueous medium and a pH sliding agent. An inkjet textile printing apparatus includes a recording head that ejects an ink toward an image formation area of a textile printing target and a first treatment head that ejects a first treatment liquid toward at least the image formation area of the textile printing target. The first treatment liquid is the above-described inkjet textile printing treatment liquid. An inkjet textile printing method incudes: inkjetting an ink toward an image formation area of a textile printing target; and inkjetting a first treatment liquid toward at least the image formation area of the textile printing target. The first treatment liquid is the above-described inkjet textile printing treatment liquid.

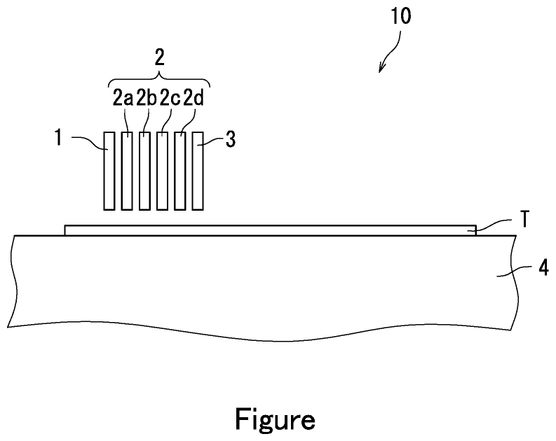

### TECHNICAL FIELD

The present invention relates to an inkjet textile printing treatment liquid, an inkjet textile printing apparatus, an inkjet textile printing method, and a textile print.

### BACKGROUND ART

Inks containing a pigment are used for example in inkjet textile printing methods. The inks containing a pigment are used in combination with a treatment liquid in order to increase color fastness to rubbing of a textile printing target with an image formed thereon (also referred to below as textile print).

For example, Patent Literature 1 proposes a pretreatment liquid containing hydroxyethyl cellulose, ammonium salt, a hydrotropy agent, and water.

### CITATION LIST

### Patent Literature

[Patent Literature 1] Japanese Patent Application Laid-Open Publication No. 2007-247109

### SUMMARY OF INVENTION

### Technical Problem

Here, the textile print is preferably weakly acidic. By contrast, the textile print formed with an ink and the pretreatment liquid disclosed in Patent Literature 1 is alkaline due to the presence of the components of the ink and the pretreatment liquid. Therefore, it is necessary to render the textile print formed with the ink and the pretreatment liquid disclosed in Patent Literature 1 weakly acidic by washing or neutralization (also referred to below collectively as washing/neutralization treatment) after textile printing.

The present invention has been made in view of the foregoing and has its object of providing an inkjet textile printing treatment liquid, an inkjet textile printing apparatus, an inkjet textile printing method that can eliminate the need of the washing/neutralization treatment of a textile print after textile printing, and a textile print.

### Solution to Problem

An inkjet textile printing treatment liquid according to the present invention contains an aqueous medium and a pH sliding agent.

An inkjet textile printing apparatus according to the present invention includes: a recording head that ejects an ink toward an image formation area of a textile printing target; and a first treatment head that ejects the first treatment liquid toward at least the image formation area of the textile printing target. The first treatment liquid is the above-described inkjet textile printing treatment liquid.

An inkjet textile printing method according to the present invention incudes: inkjetting an ink toward an image formation area of a textile printing target; inkjetting a first treatment liquid toward at least the image formation area of the textile printing target; and heating the textile printing target after the inkjetting an ink and the inkjetting a first treatment liquid. The first treatment liquid is the above-described inkjet textile printing treatment liquid.

A textile print according to the present invention is a textile print with an image formed thereon. The image contains a component derived from the above-described inkjet textile printing treatment liquid and a component derived from an ink.

### Advantageous Effects of Invention

The inkjet textile printing treatment liquid, the inkjet textile printing apparatus, and the inkjet textile printing method according to the present invention can eliminate the need of the washing/neutralization treatment on a textile print after textile printing. The textile print according to the present invention can be produced easily and has excellent color fastness to rubbing.

### BRIEF DESCRIPTION OF DRAWINGS

FIGURE is a side view of an example of an inkjet textile printing apparatus according to a second embodiment of the present invention.

### DESCRIPTION OF EMBODIMENTS

The following describes embodiments of the present invention. Note that in the present description, measured values for volume median diameter (D50) is a media diameter as measured using a laser diffraction/scattering particle size distribution analyzer (“LA-950”, product of Horiba, Ltd.) unless otherwise stated. In the following, the volume median diameter may be referred to as “D50”. A “main component” of a material refers to a component contained the most in the material in terms of mass unless otherwise stated. The term “specific gravity” refers to a specific gravity at 25° C. unless otherwise stated. The term “(meth)acrylic” is used as a generic term for both acrylic and methacrylic. One type of each component described in the present description may be used independently, or two or more types of the component may be used in combination.

An average particle diameter of particles (specifically, emulsified particles or resin particles) refers to a harmonic mean particle diameter (or may be called cumulant average particle diameter) in terms of scattered light intensity calculated based on the cumulant method. The average particle diameter of particles is measured in accordance with the method described in the International Organization for Standardization (ISO) 13321:1996 (Particle size analysis—Photon correlation spectroscopy).

### First Embodiment

### Inkjet Textile Printing Treatment Liquid

The following describes an inkjet textile printing treatment liquid (also referred to below as a treatment liquid) according to a first embodiment of the present invention. The treatment liquid of the present invention contains an aqueous medium and a pH sliding agent.

The pH sliding agent herein refers to a compound that generates an acid by being heated. Heating a solution containing the pH sliding agent decreases the pH (hydrogen ion index) of the solution. As the pH sliding agent, a compound (e.g., a salt compound containing a cation derived from a volatile base and an anion derived from a nonvolatile acid) used as a pH sliding agent known in the field of textile printing may be used or a compound used as a thermal acid generator in other fields (e.g., a field of resin formation) may be used, for example.

The treatment liquid of the present invention is suitable as a treatment liquid used for example in later described inkjet textile printing apparatus and inkjet textile printing method. The treatment liquid of the present invention is used for example in a manner to be inkjetted from a head. As such, when the treatment liquid of the present invention is inkjetted from the head, the amount of the treatment liquid of the present invention used can be smaller than that in a case in which a textile print is immersed in the treatment liquid of the present invention. Therefore, stiffening of a textile printing target hardly occurs and tactile degradation of the textile print can be inhibited.

The treatment liquid of the present invention is preferably used as a post-treatment liquid for post-treatment of inkjet textile printing. In this case, after an image is formed on an image formation area of a textile printing target with ink, the image formation area is post-treated with the treatment liquid of the present invention. Alternatively, the treatment liquid of the present invention may be used as a pretreatment liquid for pretreatment of inkjet textile printing. In this case, the image formation area is pretreated with the treatment liquid of the present invention before an image is formed on the image formation area of the textile printing target with the ink.

In a case in which the treatment liquid of the present invention is used as a post-treatment liquid for post-treatment of inkjet textile printing, it is preferable that the treatment liquid of the present invention further contains later-described emulsified particles.

As a result of the treatment liquid of the present invention having the above features, the washing/neutralization treatment on the textile print after textile printing can be omitted. The following describes a reason why the washing/neutralization treatment on the textile print after textile printing is necessitated in a known inkjet textile printing method. An ink used in the inkjet textile printing method is typically alkaline (e.g., with a pH of greater than 7 and no greater than 10). This is because an alkaline ink hardly corrodes inkjet nozzles as compared to an acidic ink and tends to allow ink components (e.g., a pigment and a resin) to stably disperse therein. A textile print produced by the known inkjet textile printing method is typically alkaline due to the presence of the ink components. By contrast, human skin is weakly acidic, and therefore it is desirable that the textile print is weakly acidic. As such, the washing/neutralization treatment is typically performed on the textile print after textile printing in the known inkjet textile printing methods. In view of the foregoing, the treatment liquid of the present invention contains a pH sliding agent. Accordingly, a textile printing target treated with the treatment liquid of the present invention contains the pH sliding agent. Further, the textile printing target is typically heated and dried after textile printing in any inkjet textile printing methods. In heating and drying, an acid is generated from the pH sliding agent in the textile printing target treated with the treatment liquid of the present invention to render the textile printing target weakly acidic. This can eliminate the need of the washing/neutralization treatment on a textile print produced with the treatment liquid of the present invention after textile printing.

Note that a method can be thought in which a pH sliding agent is added to the ink as a method by which the washing/neutralization treatment of a textile print after textile printing is omitted. However, the pH sliding agent may decrease dispersibility of the ink components dispersed in the ink. Therefore, an inkjet textile printing method using the treatment liquid of the present invention is advantageous in not affecting dispersibility of the ink components in the ink as compared to a method in which a pH sliding agent is added to the ink.

### [Aqueous Medium]

The aqueous medium contained in the treatment liquid of the present invention is a medium containing water. The aqueous medium may function as a solvent or function as a dispersion medium. Examples of the aqueous medium include an aqueous medium containing only water and an aqueous medium containing water and a water-soluble organic solvent.

The percentage content of the water in the treatment liquid of the present invention is preferably at least 30.0% by mass and no greater than 80.0% by mass, and more preferably at least 40.0% by mass and no greater than 60.0% by mass. As a result of the percentage content of the water being set to at least 30.0% by mass and no greater than 80.0% by mass, ejection stability of the treatment liquid of the present invention can be increased.

Examples of the water-soluble organic solvent contained in the treatment liquid of the present invention include glycol compounds, ether compounds of polyhydric alcohols, lactam compounds, nitrogen-containing compounds, acetate compounds, thiodiglycol, glycerin, and dimethyl sulfoxide.

Examples of the glycol compounds include ethylene glycol, 1,3-propanediol, propylene glycol, diethylene glycol, triethylene glycol, and tetraethylene glycol.

Examples of the ether compounds of polyhydric alcohols include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, and propylene glycol monomethyl ether.

Examples of the lactam compounds include 2-pyrrolidone and N-methyl-2-pyrrolidone.

Examples of the nitrogen-containing compounds include 1,3-dimethylimidazolidinone, formamide, and dimethyl formamide.

Examples of the acetate compounds include diethylene glycol monoethyl ether acetate.

The water-soluble organic solvent contained in the treatment liquid of the present invention is preferably a glycol compound, and more preferably propylene glycol.

The percentage content of the water-soluble organic solvent in the treatment liquid of the present invention is preferably at least 10.0% by mass and no greater than 60.0% by mass, and more preferably at least 25.0% by mass and no greater than 45.0% by mass. As a result of the percentage content of the water-soluble organic solvent being set to at least 10.0% by mass and no greater than 60.0% by mass, ejection stability of the treatment liquid of the present invention can be increased.

### [pH Sliding Agent]

Preferably, the pH sliding agent is an ammonium salt, a sulfonate quaternary ammonium salt, or a sulfonic acid ester. Note that an ammonium salt is a compound that is often used as a pH sliding agent in the field of textile printing. A sulfonate quaternary ammonium salt and a sulfonic acid ester are compounds that are often used as a thermal acid generator in other fields.

A preferable ammonium salt is a salt compound containing ammonium and an anion derived from a nonvolatile acid. Examples of the ammonium salt include ammonium sulfate, ammonium malate, ammonium citrate, ammonium phosphate, ammonium lactate, ammonium maleate, ammonium oxalate, and ammonium phthalate. A preferable ammonium salt is ammonium sulfate or ammonium malate. When heated, an ammonium salt generates an acid constituted by an anion and H⁺ that constitute the ammonium salt. For example, ammonium sulfate and ammonium malate generate an sulfuric acid and a malic acid, respectively, when heated.

Examples of the sulfonic quaternary ammonium salt include a salt compound of a sulfonic acid and a tetraalkylammonium. Examples of the sulfonic acid include an alkyl sulfonic acid with a carbon number of at least 1 and no greater than 5 that is optionally substituted with a halogen atom (e.g., a fluorine atom). The sulfonic acid is preferably a trifluoromethanesulfonic acid. Example of the tetraalkylammonium include tetraalkylammonium having an alkyl group with a carbon number of at least 1 and no greater than 6. The tetraalkylammonium is preferably tetrabutylammonium. A preferable sulfonate quaternary ammonium salt is tetrabutylammonium trifluoromethanesulfonate. A sulfonate quaternary ammonium salt generates a sulfonic acid when heated. For example, tetrabutylammonium trifluoromethanesulfonate generates a trifluoromethanesulfonic acid when heated.

A sulfonic acid ester is a compound represented by chemical formula “R¹—SO₂—OR²” (R¹ represents a monovalent organic group and R² represents an alkyl group). In the above chemical formula, the monovalent organic group represented by R¹ is preferably a phenyl group optionally substituted with a substituent. Examples of the substituent include an alkyl group with a carbon number of at least 8 and no greater than 15, and a dodecyl group is preferable. In the above chemical formula, the alkyl group represented by R² is preferably an alkyl group with a carbon number of at least 1 and no greater than 6, and an isobutyl group is more preferable. The sulfonic acid ester is preferably alkylbenzene sulfonic acid ester, and more preferably isobutyl dodecylbenzenesulfonate. A sulfonic acid ester generates a sulfonic acid when heated. For example, isobutyl dodecylbenzenesulfonate generates a dodecylbenzene sulfonic acid when heated.

The percentage content of the pH sliding agent in the treatment liquid of the present invention is preferably at least 0.1% by mass and no greater than 10.0% by mass, and more preferably at least 0.2% by mass and no greater than 1.0% by mass. As a result of the percentage content of the pH sliding agent being set to at least 0.1% by mass and no greater than 10.0% by mass, moderate weak acidity can be easily imparted to a formed textile print. However, the percentage content of the pH sliding agent may be changed as appropriate for example according to strength of an acid generated from the pH sliding agent or acid generation efficiency of the pH sliding agent.

### [Emulsified Particles]

The emulsified particles contain a silicone oil. The silicone oil preferably includes an ionic group-containing silicone oil. The silicone oil may further include another silicone oil (also referred to below as additional silicone oil) in addition to the ionic group-containing silicone oil. As a result of the treatment liquid of the present invention containing the emulsified particles that contain the silicone oil, the following first and second advantages can be obtained. In addition, as a result of the silicone oil including an ionic group-containing silicone oil, the following third and fourth advantages can be obtained.

The first advantage is described below. A silicone oil has a friction reducing effect. In a case in which post-treatment is performed on a textile printing target with the treatment liquid of the present invention, an image formed on the textile printing target is coated with the silicon oil to reduce the friction coefficient of the surface of the textile printing target because of the treatment liquid of the present invention containing the emulsified particles. As a result, color fading hardly occurs even when the image formed on the textile printing target is rubbed and a textile print with excellent color fastness to dry rubbing and color fastness to wet rubbing can be formed. Furthermore, as a result of the image being coated with the silicone oil with the friction reducing effect, friction between yarns of the textile printing target reduces. This can reduce stiffening of the textile printing target caused by image formation and inhibit tactile degradation of the textile print.

The second advantage will be described next. The silicone oil is water repellent. In a case in which post-treatment is performed on the textile printing target with the treatment liquid of the present invention as a post-treatment liquid, the textile printing target is coated with the water-repellent silicone oil to impart water repellency to the surface of the textile printing target because of the treatment liquid of the present invention containing the emulsified particles. As a result, color fading hardly occurs even when the image formed on the textile printing target is rubbed in a wet state and a textile print with excellent color fastness to wet rubbing can be formed.

Note that the first advantage and the second advantage can be obtained by using an ink containing a silicone oil instead of the treatment liquid of the present invention containing the silicone oil. However, in comparison between a case using the treatment liquid of the present invention containing a silicone oil and a case using the ink containing a silicone oil, the silicone oil contained in the treatment liquid of the present invention can have higher viscosity than the silicon oil contained in the ink. Use of a silicone oil with higher viscosity can form a textile print with more excellent color fastness to rubbing. Therefore, use of the treatment liquid of the present invention containing the silicone oil is more preferable than use of an ink containing a silicone oil.

The third advantage will be described next. It is thought that as a result of the silicone oil including an ionic group-containing silicone oil, bonds are formed between the ionic group and the textile printing target and between the ionic group and a component of the ink ejected on the textile printing target. As a result of bond formation, the ionic group-containing silicone oil is hardly washed off from the textile printing target and the ink with water. Accordingly, a textile print with excellent color fastness to wet rubbing can be formed.

The fourth advantage will be described next. As a result of the silicone oil including an ionic group-containing silicone oil, the emulsified particles containing the ionic group-containing silicone oil favorably disperse in the aqueous medium of the treatment liquid of the present invention. This facilitates ejection of the treatment liquid of the present invention from a treatment head of an inkjet textile printing apparatus. The first to fourth advantages have been described so far.

In a case in which the treatment liquid of the present invention contains the emulsified particles, the percentage content of the emulsified particles in the treatment liquid of the present invention is preferably at least 1.0% by mass and no greater than 20.0% by mass, and more preferably at least 5.0% by mass and no greater than 15.0% by mass. As a result of the percentage content of the emulsified particles being set to at least 1.0% by mass, color fastness to dry rubbing and tactility of the formed textile print can be increased. As a result of the percentage content of the emulsified particles being set to no greater than 15.0% by mass, color fastness to wet rubbing of the formed textile print can be increased.

The silicone oil has a viscosity of preferably at least 1000 mm²/sec. and more preferably at least 1500 mm²/sec. As a result of the viscosity of the silicone oil being set to at least 1000 mm²/sec., the silicon oil hardly separates from the formed textile print upon the formed textile print being rubbed. Therefore, color fastness to dry rubbing and color fastness to wet rubbing of the textile print can be increased. Note that a silicone oil with high viscosity may impart stiffening to the textile printing target in some cases. However, the treatment liquid of the present invention can be ejected from the head of an inkjet textile printing apparatus as described previously. The amount of the treatment liquid of the present invention used is smaller in a case in which the treatment liquid of the present invention is ejected from the head than in a case in which the textile print is immersed in the treatment liquid of the present invention. As such, stiffening of the textile printing target hardly occurs and tactile degradation of the formed textile print can be inhibited even in a case using a silicone oil with a high viscosity of 1000 mm²/sec. or more. Note that the upper limit of the viscosity of the silicone oil is preferably no greater than 100,000 mm²/sec., and more preferably no greater than 6000 mm²/sec.

The viscosity of the silicone oil is kinematic viscosity at 25° C. In a case in which the emulsified particles contain two or more silicone oils (e.g., the ionic group-containing silicone oil and an additional silicone oil), the viscosity of the silicone oil is a viscosity of the mixture of the two or more silicone oils.

The viscosity of the silicone oil is measured in accordance with the method described in Japanese Industrial Standards (JIS) Z8803:2011 (Methods for viscosity measurement of liquid). Note that the silicone oil can be extracted from the treatment liquid of the present invention for example using an organic solvent (e.g., toluene) in viscosity measurement of the silicon oil. When washed and dried, the extracted silicone oil can be served as a target of viscosity measurement.

The emulsified particles have an average particle diameter (dispersion particle diameter in the aqueous medium) of preferably at least 100 nm and no greater than 250 nm, and more preferably at least 120 nm and no greater than 220 nm. As a result of the emulsified particles having an average particle diameter of within a range as above, the treatment liquid of the present invention can be easily ejected from the head of an inkjet textile printing apparatus.

Note that the emulsified particles may further contain a component other than the silicone oil. However, the emulsified particles preferably contain only the silicon oil in order to form a textile print with excellent color fastness to rubbing and inhibit tactile degradation of the textile print.

As described previously, the silicone oil contained in the emulsified particles preferably includes an ionic group-containing silicone oil and may further include an additional silicone oil (e.g., a non-modified silicone oil).

### (Ionic Group-containing Silicone Oil)

The ionic group-containing silicone oil is a silicone oil modified with an ionic group, for example. Examples of the ionic group-containing silicone oil include a modified silicone oil with a side chain into which an ionic group has been introduced, and a modified silicone oil with an end group into which an ionic group has been introduced.

Examples of the ionic group-containing silicone oil include amino-modified silicone oils, carboxy-modified silicone oils, phenol-modified silicone oils, and silanol-modified silicon oils, and an amino-modified silicone oil is preferable. Note that the amino-modified silicone oils, the carboxy-modified silicone oils, the phenol-modified silicone oils, and the silanol-modified silicon oils respectively have an amino group, a carboxy group, a phenolic hydroxy group, and a silanol group as an ionic group.

In order to favorably disperse the emulsified particles in the aqueous medium, the ionic group-containing silicone oil preferably has a functional group equivalent of at least 1000 g/mol and no greater than 5500 g/mol. The functional group equivalent is a molecular weight per 1 mol of a functional group (ionic group).

The percentage content of the ionic group-containing silicone oil is preferably at least 30% by mass and no greater than 100% by mass relative to the total mass of the silicone oil contained in the emulsified particles, more preferably at least 40% by mass and no greater than 100% by mass, and particularly preferably 100% by mass.

In a case in which the treatment liquid of the present invention contains the emulsified particles, it is preferable that the treatment liquid of the present invention contains the emulsified particles dispersed therein and does not contain a dispersant. For example, the emulsified particles containing the ionic group-containing silicone oil favorably disperse in the aqueous medium. As such, even in a case in which the treatment liquid of the present invention contains no dispersant, the dispersion state of the emulsified particles can be maintained by the emulsified particles containing the ionic group-containing silicone oil. A dispersant has a hydrophilic group in many cases. When a dispersant having a hydrophilic group is not contained in the treatment liquid of the present invention, the textile print treated with the treatment liquid can have increased color fastness to wet rubbing. Examples of the dispersant include a surfactant, a resin dispersant, and a polysaccharide.

### [Additional Component]

The treatment liquid of the present invention may further contain a component (also referred to below as additional component) other than the aqueous medium, the pH sliding agent, and the emulsified particles as necessary. Examples of the additional component include an acid and a base.

### (Acid)

In a case in which the treatment liquid of the present invention contains emulsified particles containing an ionic group-containing silicone oil having an anionic group, it is preferable that the treatment liquid of the present invention further contains an acid. The acid prompts electrolytic dissociation of the anionic group to favorably disperse the emulsified particles containing the ionic group-containing silicone oil in the aqueous medium. Examples of the acid include strong acids and weak acids. Examples of the strong acids include hydrochloric acid, paratoluenesulfonic acid, and sulfuric acid. Examples of the weak acids include benzoic acid and acetic acid. The acid is preferably a strong acid, and more preferably hydrochloric acid, paratoluenesulfonic acid, or sulfuric acid. In a case in which the treatment liquid of the present invention contains an acid, the percentage content of the acid is preferably at least 1.0% by mass and no greater than 5.0% by mass in terms of the amount of the acid at a concentration of 1 mol/L.

### (Base)

In a case in which the treatment liquid of the present invention contains emulsified particles containing an ionic group-containing silicone oil having a cationic group, it is preferable that the treatment liquid of the present invention further contains a base. The base prompts electrolytic dissociation of the cationic group to favorably disperse the emulsified particles containing the ionic group-containing silicone oil in the aqueous medium. Examples of the base include sodium hydroxide. In a case in which the treatment liquid of the present invention contains a base, the percentage content of the base is preferably at least 1.0% by mass and no greater than 5.0% by mass in terms of the amount of the base at a concentration of 1 mol/L.

### <Preparation Method of Treatment Liquid>

The treatment liquid of the present invention can be prepared for example by mixing the pH sliding agent, the aqueous medium, and components (e.g., the emulsified particles and an acid or a base) added as necessary. In a case in which the treatment liquid of the present invention contains the emulsified particles, the treatment liquid of the present invention is preferably prepared by mixing the pH sliding agent, the aqueous medium, and a raw material emulsion containing the emulsified particles. In this case, the amount of the raw material emulsion used relative to the amount of all raw materials used is at least 15% by mass and no greater than 50% by mass, for example.

The raw material emulsion can be prepared for example by emulsifying the silicone oil, a portion of the aqueous medium, and an acid or a base used as necessary using a homogenizer. In preparation of the raw material emulsion, the emulsifying time is 5 minutes or longer and 1 hour or shorter, for example. The emulsification temperature is 5° C. or higher and 40° C. or lower, for example.

### Second Embodiment

### Inkjet Textile Printing Apparatus

An inkjet textile printing apparatus according to a second embodiment of the present invention includes recording heads that eject inks toward an image formation area of a textile printing target and a first treatment head that ejects a first treatment liquid toward at least the image formation area of the textile printing target. The first treatment liquid is the treatment liquid according to the first embodiment. Preferably, the inkjet textile printing apparatus of the present invention further includes a second treatment head that ejects a second treatment liquid toward at least the image formation area of the textile printing target. The second treatment liquid is a pretreatment liquid containing a cationic component. The inks and the second treatment liquid will be described later in detail. Use of the inkjet textile printing apparatus of the present invention, which uses the treatment liquid of the first embodiment, can eliminate the need of the washing/neutralization treatment on a textile print after textile printing.

The inkjet textile printing apparatus of the present invention will be described with reference to FIGURE. Note that FIGURE schematically illustrates constituent elements in order to facilitate understanding and properties such as size and number of each constituent element illustrated in the drawing may be altered as appropriate. FIGURE is a side view of main components of an inkjet textile printing apparatus 10 that is an example of the inkjet textile printing apparatus of the present invention. The inkjet textile printing apparatus 10 illustrated in FIGURE is a flatbed inkjet textile printing apparatus.

The inkjet textile printing apparatus 10 performs post-treatment on a textile printing target T with the treatment liquid of the first embodiment as a post-treatment liquid. Use of the inkjet textile printing apparatus 10, which uses the treatment liquid of the first embodiment, can eliminate the need of the washing/neutralization treatment on the textile print after textile printing.

The inkjet textile printing apparatus 10 illustrated in FIGURE includes a pretreatment head 1, recording heads 2, a post-treatment head 3, and a loading table 4. The recording heads 2 includes a first recording head 2a, a second recording head 2b, a third recording head 2c, and a fourth recording head 2d.

The pretreatment head 1 corresponds to the aforementioned second treatment head. The pretreatment head 1 ejects a second treatment liquid toward at least an image formation area of the textile printing target T. The second treatment liquid is a pretreatment liquid containing a cationic component. Although no particular limitations are placed on the pretreatment head 1, the pretreatment head 1 may be a piezoelectric head or a thermal inkjet head, for example. The recording heads 2 eject inks toward the image formation area of the textile printing target T. The first recording head 2a, the second recording head 2b, the third recording head 2c, and the fourth recording head 2d of the recording heads 2 eject inks mutually different in colors (e.g., a yellow ink, a magenta ink, a cyan ink, and a black ink). Although no particular limitations are placed on the recording heads 2, the recording heads 2 may be piezoelectric heads or thermal inkjet heads, for example.

The post-treatment head 3 corresponds to the aforementioned first treatment head. The post-treatment head 3 ejects a first treatment liquid toward at least the image formation area of the textile printing target T. The first treatment liquid is the treatment liquid according to the first embodiment. Although no particular limitations are placed on the post-treatment head 3, the post-treatment head 3 may be a piezoelectric head or a thermal inkjet head, for example.

The textile printing target T is loaded on the loading table 4. The pretreatment head 1, the recording heads 2, and the post-treatment head 3 are arranged above the loading table 4 so as to respectively eject the second treatment liquid, the inks, and the first treatment liquid toward the textile printing target T. When a motor (not illustrated) is driven, the loading table 4 moves horizontally in a direction (e.g., rightward in FIGURE) from the pretreatment head 1 toward the post-treatment head 3. Horizontal movement of the loading table 4 conveys the textile printing target T on the loading table 4.

The textile printing target T may be a woven fabric or a knitted fabric. Examples of the textile printing target T include a cotton fabric, a silk fabric, a linen fabric, an acetate fabric, a rayon fabric, a nylon fabric, a polyurethane fabric, and a polyester fabric. In textile print formation, the loading table 4 with the textile printing target T loaded thereon moves horizontally first to convey the textile printing target T to a location opposite to the pretreatment head 1 (second treatment head). The second treatment liquid (pretreatment liquid) is ejected from the pretreatment head 1 toward at least the image formation area of the textile printing target T. In the manner described above, pretreatment with the second treatment liquid is performed on the image formation area of the textile printing target T. Next, the textile printing target T is conveyed to a location opposite to the recording heads 2. The inks are ejected from the recording heads 2 toward the image formation area of the textile printing target T. In the manner descried above, an image is formed with the inks in the image formation area of the textile printing target T. Next, the loading table 4 with the textile printing target T loaded thereon further moves horizontally to convey the textile printing target T to a location opposite to the post-treatment head 3 (first treatment head). The first treatment liquid (post-treatment liquid) is ejected from the post-treatment head 3 toward at least the image formation area of the textile printing target T. In the manner described above, post-treatment with the post-treatment liquid is performed on the image formed in the image formation area of the textile printing target T.

The pretreatment head 1 and the post-treatment head 3 may eject the second treatment liquid and the first treatment liquid, respectively, toward only the image formation area of the textile printing target T, may eject the second treatment liquid and the first treatment liquid, respectively, toward an area of the textile printing target T wider than the image formation area, or may eject the second treatment liquid and the first treatment liquid, respectively, toward the entirety of the textile printing target T. In order to inhibit tactile degradation of the textile print by reducing the amounts of the first treatment liquid and the second treatment liquid used, the pretreatment head 1 and the post-treatment head 3 preferably eject the second treatment liquid and the first treatment liquid, respectively, toward only the image formation area of the textile printing target T, and more preferably eject the second treatment liquid and the first treatment liquid, respectively, toward only an area of the image formation area where the inks are to be or have been ejected by the recording heads 2. Ejection points of the pretreatment head 1 and the post-treatment head 3 can be accurately controlled. Therefore, the pretreatment head 1 and the post-treatment head 3 can eject the second treatment liquid and the first treatment liquid, respectively, toward only the area toward which the inks are to be or have been ejected. In order to accurately control the points toward which the first treatment liquid and the second treatment liquid are to be ejected, the distance between the textile printing target T and the pretreatment head 1 or the post-treatment head 3 is preferably at least 1 mm and no greater than 5 mm.

After the first treatment liquid is ejected toward the textile printing target T from the post-treatment head 3, the loading table 4 with the textile printing target T loaded thereon further moves horizontally to convey the textile printing target T to a location opposite to a heater (not illustrated). The heater heats the textile printing target T to evaporate the inks, the first treatment liquid, and the second treatment liquid. The heating temperature is 120° C. or higher and 180° C. or lower, for example. The heating time is 1 minute or longer and 10 minutes or shorter, for example. Heating evaporates volatile components contained in the inks, the first treatment liquid, and the second treatment liquid to prompt fixation of the inks, the first treatment liquid, and the second treatment liquid to the textile printing target T. Also, an acid is generated from the pH sliding agent contained in the first treatment liquid. Through the above, a textile print is formed. The washing/neutralization treatment is not necessary because the textile print is rendered weakly acidic by the acid generated from the pH sliding agent.

The inkjet textile printing apparatus 10 has been described so far. However, the inkjet textile printing apparatus of the present invention is not limited to the inkjet textile printing apparatus 10 and can be altered as follows, for example. In the inkjet textile printing apparatus of the present invention, the pretreatment head 1 that ejects the second treatment liquid, the loading table 4, and the heater each are an optional element of configuration and may be omitted. Note that in a case in which the inkjet textile printing apparatus of the present invention does not include the hater, a textile print formed by the inkjet textile printing apparatus of the present invention needs to be heat-treated (e.g., heating temperature of 120° C. or higher and 180° C. or lower, heating time of 1 minute or longer and 10 minutes or shorter). An acid is generated from the pH sliding agent contained in the first treatment liquid by heat treatment to render the textile print weakly acidic. Furthermore, the order of ejection of the inks and ejection of the first treatment liquid may be changed in the inkjet textile printing apparatus of the present invention. Specifically, the first treatment head may eject the first treatment liquid toward at least the image formation area of the textile printing target T before ink ejection by the recording heads toward the image formation area of the textile printing target T, simultaneously with ink ejection, or after ink ejection. Furthermore, the pretreatment head, the recording heads, and the post-treatment head may move horizontally with the loading table being stationary in the inkjet textile printing apparatus of the present invention. Moreover, the number of the recording heads included in the inkjet textile printing apparatus of the present invention may be 1 to 3 or 5 or more. In addition, the inkjet textile printing apparatus of the present invention may be an inkjet textile printing apparatus that is not of flatbed type.

### Third Embodiment

### Inkjet Textile Printing Method

An inkjet textile printing method according to a third embodiment of the present invention will be described next. The inkjet textile printing method of the present invention includes: an ink ejection process of inkjetting an ink toward an image formation area of a textile printing target; a first treat treatment process of inkjetting a first treatment liquid toward at least the image formation area of the textile printing target; and a heating process of heating the textile printing target after the inkjetting process and the first treatment process. The first treatment liquid is the treatment liquid according to the first embodiment. Preferably, the inkjet textile printing method of the present invention further includes a second treatment process of ejecting a second treatment liquid toward at least the image formation area of the textile printing target before the ink ejection process. The second treatment liquid is a pretreatment liquid containing a cationic component. The inkjet textile printing method of the present invention, which uses the treatment liquid of the first embodiment, can eliminate the need of the washing/neutralization treatment on a textile print after textile printing.

### [Ink Ejection Process]

In the ink ejection process, an image is formed with an ink in the image formation area of the textile printing target. In the ink ejection process, the amount of the ink ejected toward the textile printing target is at least 5 g/m² and no greater than 40 g/m², for example.

### [First Treatment Process]

The textile printing target is treated with the first treatment liquid in the first treatment process (perform pretreatment or post-treatment). The first treatment process may be performed before the ink ejection process or may be performed after the ink ejection process. That is, the first treatment process may be a pretreatment process or a post-treatment process.

In the first treatment process, the amount of the first treatment liquid ejected toward the textile printing target is preferably at least 10 g/m² and no greater than 120 g/m², and more preferably at least 15 g/m² and no greater than 30 g/m².

### [Second Treatment Process]

In the second treatment process, the textile printing target is pretreated with the second treatment liquid. In the second treatment process, the amount of the second treatment liquid ejected toward the textile printing target is at least 5 g/m² and no greater than 40 g/m², for example.

### [Heating Process]

In the heating process, the textile printing target is heated to evaporate the ink, the first treatment liquid, and the second treatment liquid used as necessary and generate an acid from the pH sliding agent contained in the first treatment liquid. The heating temperature in the heating process is 120° C. or higher and 180° C. or lower, for example. The heating time is 1 minute or longer and 10 minutes or shorter, for example.

### [Second Treatment Liquid and Inks Used in Second Embodiment and Third Embodiment]

The second treatment liquid (pretreatment liquid) and the inks used in the second embodiment and the third embodiment will be described next.

### [Second Treatment Liquid]

The second treatment liquid contains a cationic component. Examples of the cationic component include a cationic surfactant and binder resin particles containing a cationic resin. The second treatment liquid preferably contains a cationic surfactant and binder resin particles containing a cationic resin. The second treatment liquid may further contain at least one selected from the group consisting of a nonionic surfactant and an aqueous medium as necessary.

### (Binder Resin Particles)

The binder resin particles contain a cationic resin. The percentage content of the cationic resin in the binder resin particles is preferably at least 80% by mass, more preferably at least 95% by mass, and further preferably 100% by mass.

The binder resin particles have a Dso of preferably at least 20 nm and no greater than 200 nm, and more preferably at least 30 nm and no greater than 100 nm. As a result of the D50 of the binder resin particles being set to at least 20 nm and no greater than 200 nm, a formed textile print can have increased color fastness to rubbing. Also, as a result of the D50 of the binder resin particles being set to no greater than 200nm, occurrence of nozzle clogging in ejection of the second treatment liquid from nozzles can be inhibited.

The percentage content of the binder resin particles in the second treatment liquid is preferably at least 1.0% by mass and no greater than 15.0% by mass, and more preferably at least 2.0% by mass and no greater than 5.0% by mass. As a result of the percentage content of the binder resin particles being set to at least 1.0% by mass, the formed textile print can have increased color fastness to rubbing. As a result of the percentage content of the binder resin particles being set to no greater than 15.0% by mass by contrast, coatability of the second treatment liquid can be increased. Also, as a result of the percentage content of the binder resin particles being set to no greater than 15.0% by mass, occurrence of nozzle clogging in ejection of the second treatment liquid from the nozzles can be inhibited.

### (Cationic Resin)

Examples of the cationic resin include (meth)acrylic resins having an amino group and (meth)acrylic resins having a functional group derived from a quaternary ammonium salt.

The (meth)acrylic resins are resins including a unit derived from a (meth)acrylic acid or a (meth)acrylic acid ester. Examples of the (meth)acrylic resins having an amino group include copolymers of a (meth)acrylic acid ester and a monomer having an amino group. Examples of the (meth)acrylic resins having a functional group derived from a quaternary ammonium salt include copolymers of a (meth)acrylic acid ester and a monomer having a functional group derived from a quaternary ammonium salt.

Examples of the (meth)acrylic acid ester include (meth)acrylic acid alkyl esters. Examples of the (meth)acrylic acid alkyl esters include methyl (meth)acrylate, ethyl (meth)acrylate, butyl (meth)acrylate, 2-ethylhexyl (meth)acrylate, and lauryl (meth)acrylate.

Examples of the monomer having an amino group include (meth)acrylic acid dialkylaminoalkyl esters (e.g., diethylaminoethyl (meth)acrylate), alkenylic acid dialkylaminoalkyl esters (e.g., 2-propenoic acid 2-(dimethylamino)ethyl), dialkyl (meth)acrylamides (e.g., dimethylacrylamide), dialkylaminoalkyl (meth)acrylamides (e.g., dimethylaminopropyl acrylamide and dimethylaminopropyl methacrylamide), and N-alkyl(meth)acrylamides (e.g., N-isopropylacrylamide).

Examples of the monomer having a functional group derived from a quaternary ammonium salt include monomers obtained by quaternizsing the above monomer having the amino group. The monomer having a functional group derived from a quaternary ammonium salt is preferably a quaternary salt of dimethylamiopropyl acrylamide.

The cationic resin is preferably a (meth)acrylic resin having a functional group derived from a quaternary ammonium salt, and more preferably a copolymer of butyl acrylate and a quaternary salt of dimethylaminopropyl acrylamide.

### (Cationic Surfactant)

Examples of the cationic surfactant include amine salt surfactants and quaternary ammonium salt surfactants. Examples of the amine salt surfactants include alkylamine acetates having an alkyl group with a carbon number of at least 10 and no greater than 25 (e.g., stearylamine acetate). Examples of the quaternary ammonium salt surfactants include alkyl trimethyl ammonium salts having an alkyl group with a carbon number of at least 10 and no greater than 25 (e.g., cetyltrimethylammonium chloride). The cationic surfactant is preferably a quaternary ammonium salt surfactant, and more preferably cetyltrimethylammonium chloride.

In a case in which the second treatment liquid contains a cationic surfactant, the percentage content of the cationic surfactant in the second treatment liquid is preferably at least 0.1% by mass and no greater than 3.0% by mass, and more preferably at least 0.3% by mass and no greater than 1.0% by mass. As a result of the percentage content of the cationic surfactant being set to at least 0.1% by mass, dispersibility of the binder resin particles can be increased. As a result of the percentage content of the cationic surfactant being set to no greater than 3.0% by mass, color fastness to rubbing of the formed textile print can be increased.

### (Aqueous Medium)

Examples of the aqueous medium contained in the second treatment liquid include aqueous mediums similar to the aqueous medium described in the first embodiment.

### (Water)

The percentage content of the water in the second treatment liquid is preferably at least 20.0% by mass and no greater than 70.0% by mass, and more preferably at least 40.0% by mass and no greater than 60.0% by mass. As a result of the percentage content of the water being set to at least 20.0% by mass and no greater than 70.0% by mass, ejection stability of the second treatment liquid can be increased.

### (Water-Soluble Organic Solvent)

Examples of the water-soluble organic solvent contained in the second treatment liquid include compounds similar to the water-soluble organic solvent described in the first embodiment. The water-soluble organic solvent is preferably a glycol compound, and more preferably propylene glycol.

In a case in which the second treatment liquid contains a water-soluble organic solvent, the percentage content of the water-soluble organic solvent in the second treatment liquid is preferably at least 10.0% by mass and no greater than 60.0% by mass, and more preferably at least 30.0% by mass and no greater than 50.0% by mass. As a result of the percentage content of the water-soluble organic solvent being set to at least 10.0% by mass and no greater than 60.0% by mass, ejection stability of the second treatment liquid can be increased.

### (Nonionic Surfactant)

A nonionic surfactant adjusts surface tension of the second treatment liquid. The nonionic surfactant is preferably an acetylene glycol surfactant, and more preferably ethylene oxide adduct of acetylenediol.

In a case in which the second treatment liquid contains a nonionic surfactant, the percentage content of the nonionic surfactant in the second treatment liquid is preferably at least 0.1% by mass and no greater than 5.0% by mass, and more preferably at least 0.3% by mass and no greater than 1.0% by mass. As a result of the percentage content of the nonionic surfactant being set to at least 0.1% by mass and no greater than 5.0% by mass, ejectability of the second treatment liquid can be increased.

### [Second Treatment Liquid Preparation Method]

The second treatment liquid can be prepared for example in a manner that additional components (e.g., water, the water-soluble organic solvent, and the nonionic surfactant) are added to a raw material emulsion containing the binder resin particles as necessary and the resultant mixture is mixed uniformly using a stirrer. The raw material emulsion can be prepared for example by emulsion polymerization using a cationic surfactant and a monomer that is a raw material of a cationic resin.

### [Ink]

Each of the inks contains a pigment and an aqueous medium, for example. The inks may further contain at least one selected from the group consisting of a surfactant and binder resin particles as necessary.

### (Pigment)

The pigment is present in a dispersed state in the aqueous medium, for example. In terms of obtaining an ink excellent in image density, hue, and color stability, the pigment has a Dso of preferably at least 30 nm and no greater than 250 nm, and more preferably at least 70 nm and no greater than 160 nm.

Examples of the pigment include yellow pigments, orange pigments, red pigments, blue pigments, violet pigments, and black pigments. Examples of the yellow pigments include C.I. Pigment Yellow (74, 93, 95, 109, 110, 120, 128, 138, 139, 151, 154, 155, 173, 180, 185, or 193). Examples of the orange pigments include C.I. Pigment Orange (34, 36, 43, 61, 63, or 71). Examples of the red pigments include C.I. Pigment Red (122 or 202). Examples of the blue pigments include C.I. Pigment Blue (15, more specifically 15:3). Examples of the violet pigments include C.I. Pigment Violet (19, 23, or 33). Examples of the black pigments include C.I. Pigment Black (7).

The percentage content of the pigment in the ink is preferably at least 1% by mass and no greater than 12% by mass, and more preferably at least 1% by mass and no greater than 7% by mass. As a result of the percentage content of the pigment being set to at least 1.0% by mass, the formed textile print can have increased image density. As a result of the percentage content of the pigment being set to no greater than 12% by mass, the ink can have high fluidity.

### (Aqueous Medium)

Examples of the aqueous medium contained in the ink include aqueous mediums similar to the aqueous medium descried in the first embodiment.

### (Water)

The percentage content of the water in the ink is preferably at least 20.0% by mass and no greater than 70.0% by mass, and more preferably at least 40.0% by mass and no greater than 60.0% by mass. As a result of the percentage content of the water being set to at least 20.0% by mass and no greater than 70.0% by mass, ejection stability of the ink can be increased.

### (Water-Soluble Organic Solvent)

Examples of the water-soluble organic solvent contained in the ink include compounds similar to the water-soluble organic solvent described in the first embodiment. The water-soluble organic solvent is preferably a glycol compound, and more preferably propylene glycol.

In a case in which the ink contains a water-soluble organic solvent, the percentage content of the water-soluble organic solvent in the ink is preferably at least 10.0% by mass and no greater than 60.0% by mass, and more preferably at least 25.0% by mass and no greater than 45.0% by mass. As a result of the percentage content of the water-soluble organic solvent being set to at least 10.0% by mass and no greater than 60.0% by mass, ejection stability of the ink can be increased.

### (Surfactant)

As a result of the ink containing a surfactant, the ink has increased wettability to the textile printing target. Examples of the surfactant include anionic surfactants, cationic surfactants, nonionic surfactants, and amphoteric surfactants. The surfactant contained in the ink is preferably a nonionic surfactant. The nonionic surfactant is preferably an acetylene glycol surfactant, and more preferably ethylene oxide adduct of acetylenediol. In order to increase image density while inhibiting image offset, the percentage content of the surfactant in the ink is preferably at least 0.1% by mass and no greater than 5.0% by mass.

### (Binder Resin Particles)

The binder resin particles contained in the ink are present in a dispersed state in the aqueous medium. The binder resin particles function as a binder that bonds the textile printing target and the pigment. As such, a textile print with excellent pigment fixability can be obtained by the ink containing the binder resin particles.

Examples of the resin contained in the binder resin particles in the ink include urethane resins, (meth)acrylic resins, styrene-(meth)acrylic resins, styrene-maleic acid copolymers, vinylnaphthalene-(meth)acrylic acid copolymers, and vinylnaphthalene-maleic acid copolymers. The resin contained in the binder resin particles is preferably a urethane resin.

In a case in which the ink contains the binder resin particles, the percentage content of the binder resin particles in the ink is preferably at least 1% by mass and no greater than 20% by mass, and more preferably at least 4% by mass and no greater than 10% by mass. As a result of the percentage content of the binder resin particles being set to at least 1% by mass, a textile printing target with excellent pigment fixability can be obtained. As a result of the percentage content of the binder resin particles being set to no greater than 20% by mass, ejection stability of the ink can be increased.

### (Additive)

The ink may further contain a known additive (specific examples include a solution stabilizer, an anti-drying agent, an antioxidant, a viscosity modifier, a pH adjuster, and an antifungal agent) as necessary.

### (Ink Production Method)

The ink is produced for example by mixing the pigment, the aqueous medium, and the components (e.g., the surfactant and the binder resin particles) added as necessary using a stirrer. The mixing time is 1 minute or longer and 30 minutes or shorter, for example.

### Fourth Embodiment

### Textile Print

A textile print according to a fourth embodiment of the present invention will be described next. The textile print of the present invention is a textile print with an image formed thereon. The image contains a component derived from the treatment liquid described in the first embodiment and a component derived from an ink. The textile print of the present invention is formed with the ink and the treatment liquid according to the first embodiment, for example. As such, the textile print of the present invention can be produced easily and has excellent color fastness to rubbing.

Examples of the component derived from the treatment liquid include a silicon oil and an acid derived from the pH sliding agent. Example of the component derived from the ink include a pigment and a binder resin. The image may further contain a component (e.g., the aforementioned cationic component) derived from the second treatment liquid described previously.

### EXAMPLES

Hereinafter, examples of the present invention will be described. However, the present invention is in no way limited to the following examples.

### [Average Particle Diameter Measurement]

In Examples, the particle diameter (cumulant average particle diameter) of particles was obtained by measurement by a method in accordance with the method described in ISO 13321:1996 (Particle size analysis—Photon correlation spectroscopy) using a laser diffraction particle size distribution analyzer (“ZETASIZER NANO ZS”, product of Malvern Instruments Ltd.) and calculation by the cumulant method. A measurement sample obtained by diluting an evaluation target 1000 times with water was used in the particle diameter measurement of particles.

### [Preparation of Pretreatment Liquid (P)]

A 1-L three-necked flask (reaction vessel) equipped with a thermometer and a stirring impeller was charged with 790.0 g of ion exchange water and 29.0 g of a cationic surfactant (“QUARTAMIN (registered Japanese trademark) 24P”, product of Kao Corporation, lauryltrimethylammonium chloride). Next, the internal temperature of the reaction vessel was increased to 80° C. using a water bath. Separately, a mixed liquid A and a mixed liquid B were prepared. The mixed liquid A contained 89.4 g of butyl acrylate and 47.5 g of dimethylaminopropyl acrylamide methyl chloride quaternary salt. The mixed liquid B contained 0.5 g of potassium peroxodisulfate and 30.0 g of ion exchange water. Next, the mixed liquid A and the mixed liquid B were dripped into the reaction vessel over 5 hours while the internal temperature of the reaction vessel was kept at 80° C. Next, the internal temperature of the reaction vessel was kept at 80° C. for 2 hours to allow a polymerization reaction to occur. Through the above, a resin particle dispersion containing binder resin particles containing a cationic resin was obtained. The binder resin particles in the resultant resin particle dispersion had an average particle diameter (cumulant average particle diameter) of 50 nm.

A pretreatment liquid (P) was obtained by mixing 20 g of the above-described resin particle dispersion, 40 g of ion exchange water, 39.5g of propylene glycol, and 0.5 g of a nonionic surfactant (“SURFYNOL” (registered Japanese trademark) 440″, product of Nissin Chemical Industry Co., Ltd.). The pretreatment liquid (P) corresponds to the second treatment liquid described in the second embodiment and the third embodiment.

### [Raw Material Emulsion Preparation]

A beaker was charged with 300 g of an amino modified silicone oil (“KF-864”, product of Shin-Etsu Chemical Co., Ltd., viscosity: 1700 mm²/sec., specific gravity: 0.98, functional group equivalent: 3800 g/mol), 600 g of ion exchange water, and 100 g of hydrochloric acid (concentration: 1 mol/L). The beaker contents were stirred at a rotational speed of 10,000 rpm for 15 minutes using a homogenizer (“ULTRA-TURRAX T25”, product of IKA Works). Thereafter, the beaker was left to stand for 30 minutes. Next, the beaker contents were filtered using a 120-mesh stainless filter. Through the above, a raw material emulsion was obtained. Emulsified particles containing the amino modified silicone oil were dispersed in the raw material emulsion. The emulsified particles contained in the raw material emulsion had an average particle diameter (cumulant average particle diameter) of 150 nm.

### [Preparation of Post-treatment Liquid (A-1)]

Mixing was performed of 30.0 g of the raw material emulsion, 32.0 g of ion exchange water, 32.0 g of propylene glycol being the water-soluble organic solvent, and 6.0 g of ammonium sulfate being the pH sliding agent. Through the mixing, a post-treatment liquid (A-1) was prepared.

### [Preparation of Post-Treatment Liquid (A-2)]

Mixing was performed of 30.0 g of the raw material emulsion, 32.0 g of ion exchange water, 32.0 g of propylene glycol being the water-soluble organic solvent, and 6.0 g of ammonium malate being the pH sliding agent. Through the mixing, a post-treatment liquid (A-2) was prepared.

### [Preparation of Post-Treatment Liquid (A-3)]

Mixing was performed of 30.0 g of the raw material emulsion, 32.0 g of ion exchange water, 32.0 g of propylene glycol being the water-soluble organic solvent, and 0.4 g of tetrabutylammonium trifluoromethanesulfonate being the pH sliding agent. Through the mixing, a post-treatment liquid (A-3) was prepared.

### [Preparation of Post-Treatment Liquid (A-4)]

Mixing was performed of 30.0 g of the raw material emulsion, 32.0 g of ion exchange water, 32.0 g of propylene glycol being the water-soluble organic solvent, and 0.4 g of isobutyl dodecylbenzenesulfonate being the pH sliding agent. Through the mixing, a post-treatment liquid (A-4) was prepared.

[Preparation of Post-Treatment Liquid (a-1)]

Mixing was performed of 30.0 g of the raw material emulsion, 35.0 g of ion exchange water, and 35.0 g of propylene glycol being the water-soluble organic solvent. Through the mixing, a post-treatment liquid (a-1) was prepared.

The post-treatment liquids (A-1) to (A-4) each correspond to the treatment liquid (treatment liquid describe in the first embodiment and the first treatment liquid described in the second embodiment and the third embodiment) of the present invention.

Note that the post-treatment liquid (a-1) is a post-treatment liquid different from the treatment liquid of the present invention.

Table 1 below shows types and percentage contents of the pH sliding agents contained in the post-treatment liquids (A-1) to (A-4) and (a-1). In Table 1 below, “-” indicates that no corresponding component was contained.

TABLE 1

pH sliding agent

| | | Percentage content |
|---|---|---|
| | Type | [% by mass] |
| A-1 | Ammonium sulfate | 6.0 |
| A-2 | Ammonium malate | 6.0 |
| A-3 | Tetrabutylammonium | 0.4 |
| | trifluoromethanesulfonate | |
| A-4 | Isobutyl dodecylbenzenesulfonate | 0.4 |
| a-1 | — | — |

### [Preparation of Ink (I-1)]

A 1-L three-necked flask equipped with a stirring impeller was charged with 125 g of ion exchange water and 2 g of a nonionic surfactant (“SURFYNOL (registered Japanese trademark) 440”, product of Nissin Chemical Industry Co., Ltd., acetylene glycol surfactant). Next, 165 g of propylene glycol, 100 g of a pigment dispersion (“AE2078F”, product of SANYO COLOR WORKS, Ltd., C.I. Pigment Black 7, solid content 20% by mass) containing a black pigment, and 108 g of a binder resin particle dispersion (“SUPERFLEX 470”, product of DKS Co. Ltd., urethane resin particle emulsion, solid content 38% by mass) containing binder resin particles were added into the three-necked flask in the stated order while the contents of the three-necked flask were stirred. Next, the contents of the three-necked flask were stirred for 10 minutes. Through the above, an ink (I-1) was obtained.

### [Preparation of Ink (I-2)]

A 1-L three-necked flask equipped with a stirring impeller was charged with 140 g of ion exchange water and 2 g of a nonionic surfactant (“SURFYNOL (registered Japanese trademark) 440”, product of Nissin Chemical Industry Co., Ltd., acetylene glycol surfactant). Next, 225 g of propylene glycol, 83 g of a pigment dispersion (“AC-AK1”, product of Dainichiseika Color & Chemicals Mfg. Co., Ltd., C.I. Pigment Black 7, solid content 15% by mass) containing a black pigment, and 50 g of a binder resin particle dispersion (“ETERNACOL (registered Japanese trademark) UW-1527F”, product of Ube Industries, Ltd., urethane resin particle emulsion, solid content 40% by mass) containing binder resin particles were added into the three-necked flask in the stated order while the contents of the three-necked flask were stirred. Next, the contents of the three-necked flask were stirred for 10 minutes. Through the above, an ink (I-2) was obtained.

### <Evaluation>

Evaluation textile prints were formed by the following method. The combinations of pretreatment liquids, inks, and post-treatment liquids shown in Table 2 were used in formation of the evaluation textile prints. Next, the pH of an aqueous extract extracted from each of the formed evaluation textile prints was measured. The results of the measurement are shown in Table 2 below.

### [Textile Printing Target and Evaluation Apparatus]

A cotton broadcloth (product of SHIKISENSHA CO., LTD., size: A4 size, cotton counts of warp yarn and weft yarn: 40/1, warp yarn density: 130 yarns/inch, weft yarn density: 75 yarns/inch, fiber grammage: 122 g/m²) was used as a textile printing target. An inkjet printer (“COLORIO (registered Japanese trademark) PX-045A”, product of SEIKO EPSON CORPORATION) was used as an evaluation apparatus. A pretreatment liquid (specifically, the pretreatment liquid (P)) was loaded into a first ink chamber of a first cartridge. An ink (specifically, either the ink (I-1) or the ink (I-2)) was loaded into a second ink chamber of a second cartridge. A post-treatment liquid (specifically, any of the post-treatment liquid (A-1) to (A-4) and (a-1)) was loaded into a third ink chamber of a third cartridge. The first cartridge, the second cartridge, and the third cartridge were attached to the inkjet printer. Note that the pretreatment liquid loaded in the first ink chamber is ejected from a pretreatment head of the inkjet printer. The ink loaded in the second ink chamber is ejected from recording heads of the inkjet printer. The post-treatment liquid loaded in the third ink chamber is ejected from a post-treatment head of the inkjet printer.

### [Inkjet Textile Printing]

Using the evaluation apparatus, the pretreatment liquid was ejected toward the textile printing target from the pretreatment head so that the amount of the pretreatment liquid ejected was 10 g/m². In the manner described above, pretreatment was performed on an image formation area of the textile printing target. Next, using the evaluation apparatus, the ink was ejected toward the textile printing target from the recording heads so that the amount of the ink ejected was 20 g/m². In the manner described above, a solid image was formed on the image formation area of the textile printing target. Next, using the evaluation apparatus, the post-treatment liquid was ejected toward the textile printing target from the post-treatment head so that the amount of the post-treatment liquid ejected was 20 g/m². In the manner described above, post-treatment was performed on the image formation area of the textile printing target. Next, the textile printing target was heated at 160° C. for 3 minutes to evaporate the pretreatment liquid, the ink, and the post treatment liquid. Thus, an evaluation textile print was obtained.

### [pH Measurement]

A glass flask (container) was charged with 50 mL of distilled water. Next, the container was heated to boil the distilled water in the container for 2 minutes. Next, 5.0 g of the evaluation textile print that had been finely cut was added into the container. Next, the container was corked and left to stand at room temperature for 30 minutes. Next, the liquid temperature of the liquid (aqueous extract) in the container was adjusted to 25° C.±2° C. Next, the pH of the aqueous extract was measured using a pH meter (“D73-S”, product of HORIBA, Ltd.). The aqueous extract was determined to be acceptable (A) if the pH thereof was at least 5.0 and no greater than 7.0 and determined to be rejected (B) if the pH thereof was less than 5.0 or greater than 7.0. It is determined that the evaluation textile print needs no washing/neutralization treatment because of being weakly acidic if the aqueous extract was determined to be acceptable in the pH measurement. It is determined that the evaluation textile print needs the washing/neutralization treatment because of not being weakly acidic if the aqueous extract was determined to be rejected in the pH measurement.

TABLE 2

| | Textile printing | | | | |
|---|---|---|---|---|---|
| | Pretreatment | | Post-treatment | Evaluation | |
| | liquid | Ink | liquid | pH | Determination |
| Example 1 | P | I-1 | A-1 | 6.7 | A |
| Example 2 | P | I-1 | A-2 | 6.4 | A |
| Example 3 | P | I-2 | A-1 | 6.3 | A |
| Example 4 | P | I-1 | A-3 | 6.1 | A |
| Example 5 | P | I-1 | A-4 | 5.9 | A |
| Comparative | P | I-1 | a-1 | 7.8 | B |
| Example 1 | | | | | |

The post treatment liquids (A-1) to (A-4) each contained an aqueous medium and a pH sliding agent. As shown in Table 2, the respective textile prints formed with the post-treatment liquids (A-1) to (A-4) were weakly acidic and needed no washing/neutralization treatment.

By contrast, the post-treatment liquid (a-1) did not have the above features. As a result, the textile print formed with the post-treatment liquid (a-1) needed the washing/neutralization treatment after textile printing.

### INDUSTRIAL APPLICABILITY

The treatment liquid, the inkjet textile printing apparatus, and the inkjet textile printing method according to the present invention can be used for textile print formation. The textile print according to the present invention can be used as clothing or a material of clothing.

1. An inkjet textile printing treatment liquid comprising:
an aqueous medium;
a pH sliding agent; and
emulsified particles containing a silicone oil, wherein
the inkjet textile printing treatment liquid is a post-treatment liquid for post-treatment of inkjet textile printing.

2. The inkjet textile printing treatment liquid according to claim 1, wherein
the pH sliding agent contains an ammonium salt, a sulfonate quaternary ammonium salt, or a sulfonic acid ester.

3. The inkjet textile printing treatment liquid according to claim 2, wherein
the ammonium salt includes ammonium sulfate or ammonium malate,
the sulfonate quaternary ammonium salt includes tetrabutylammonium trifluoromethanesulfonate, and
the sulfonic acid ester includes isobutyl dodecylbenzenesulfonate.

4. The inkjet textile printing treatment liquid according to claim 1, wherein
a percentage content of the pH sliding agent is at least 0.1% by mass and no greater than 10.0% by mass.

5-6. (canceled)

7. The inkjet textile printing treatment liquid according to claim 1, wherein
the emulsified particles have an average particle diameter of at least 100 nm and no greater than 250 nm.

8. The inkjet textile printing treatment liquid according to claim 1, wherein
the inkjet textile printing treatment liquid contains the emulsified particles dispersed therein and does not contain a dispersant.

9. An inkjet textile printing apparatus comprising:
a recording head configured to eject an ink toward an image formation area of a textile printing target;
a first treatment head configured to eject a first treatment liquid toward at least the image formation area of the textile printing target, and
a second treatment head configured to eject a second treatment liquid toward at least the image formation area of the textile printing target, wherein
the first treatment liquid is the inkjet textile printing treatment liquid according to claim 1, and
the second treatment liquid is a pretreatment liquid containing a cationic component.

10-11. (canceled)

12. An inkjet textile printing method comprising:
inkjetting an ink toward an image formation area of a textile printing target;
inkjetting a first treatment liquid toward at least the image formation area of the textile printing target;
heating the textile printing target after the inkjetting an ink and the inkjetting a first treatment liquid; and
ejecting a second treatment liquid toward at least the image formation area of the textile printing target, wherein
the first treatment liquid is the inkjet textile printing treatment liquid according to claim 1, and
the second treatment liquid is a pretreatment liquid containing a cationic component.

13. (canceled)

14. The inkjet textile printing method according to claim 12, wherein an amount of the first treatment liquid ejected is at least 15 g/m2 and no greater than 30 g/m2.

15. A textile print comprising an image formed thereon, wherein
the image contains a component derived from the inkjet textile printing treatment liquid according to claim 1 and a component derived from an ink.
